(19) United States
(12) Patent Application Publication
(10) Pub. No.: US 2009/0225319 A1
(43) Pub. Date: Sep. 10, 2009

(54) METHODS OF USING OPTOFLUIDIC MICROSCOPE DEVICES

(75) Inventors: Lap Man Lee, Pasadena, CA (US); Xiquan Cui, Pasadena, CA (US); Changhuei Yang, Pasadena, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: California Institute of Technology, Pasadena, CA (US)

(21) Appl. No.: 12/398,098

(22) Filed: Mar. 4, 2009

Related U.S. Application Data
(60) Provisional application No. 61/068,132, filed on Mar. 4, 2008.

(51) Int. Cl. G01N 21/00

(52) U.S. Cl. 356/436

(57) ABSTRACT

An embodiment of a method comprises providing a fluid sample having objects to an optofluidic microscope device comprising a fluid channel and a light detector, and receiving time varying light data from the fluid sample. The embodiment of the method also comprises determining one or more characteristics of the objects based on the time varying light data, and determining one or more phenotypes associated with the objects based on the determined characteristics.

### CROSS-REFERENCES TO RELATED APPLICATIONS

This is a non-provisional patent application that claims the benefit of the filing date of U.S. Provisional Patent Application No. 61/068,132 entitled “Optofluidic Microscope” filed on Mar. 4, 2008. That provisional application is hereby incorporated by reference in its entirety for all purposes.

This non-provisional application is related to the following co-pending and commonly-assigned patent applications, which are hereby incorporated by reference in their entirety for all purposes:
U.S. patent application Ser. No. 11/125,718 entitled “Optofluidic Microscope Device” filed on May 9, 2005.
U.S. patent application Ser. No. 11/686,095 entitled “Optofluidic Microscope Device” filed on Mar. 14, 2007.
U.S. patent application Ser. No. 11/743,581 entitled “On-chip Microscope/Beam Profiler based on Differential Interference Contrast and/or Surface Plasmon Assisted Interference” filed on May 2, 2007.

The following non-provisional patent application is being filed on the same day and is hereby incorporated by reference in its entirety for all purposes: U.S. Patent Application No. ______ filed ______, entitled “Optofluidic Microscope Device with Photosensor Array” (Attorney Docket No. 020859-011010US).

### STATEMENT AS TO RIGHTS TO INVENTIONS MADE UNDER FEDERALLY SPONSORED RESEARCH OR DEVELOPMENT

The U.S. Government has certain rights in this invention pursuant to Grant No. EB005666 awarded by the National Institutes of Health and Grant No. HR0011-04-1-0032 awarded by DARPA.

### BACKGROUND OF THE INVENTION

Embodiments of the present invention generally relate to optofluidic microscope (OFM) devices. More specifically, certain embodiments relate to methods of using an OFM device(s) to analyze fluid samples.

Microscopes and other optical microscopy devices are used extensively in all aspects of medicine and biological research. In a medical setting, clinicians typically use prepare having smears of fluid samples (e.g., blood samples) or other preparations. The slides are used to view and analyze the fluid samples under a microscope. Preparing slides takes time, potentially contaminates the samples, and adds cost to the analysis and diagnosis of illnesses. Further, conventional microscopes, upon which the slides are viewed, can be costly and relatively bulky. Bulky conventional microscopes may be unsuitable in certain situations such as in space or battlefield scenarios.

Some relatively recent advances in optical microscopy provide more compact systems, but present significant technical barriers. One prior device eliminates lenses altogether. In this device, an object is placed on a light detector (e.g., a complementary-symmetry metal-oxide-semiconductor (CMOS) light detector). Light from a light source positioned above the object, passes through the object onto the light detector. The light detector reads the light passing through the object at a single time to take a snapshot image of the object. The resolution of the snapshot image is limited by the pixel size (e.g., 10 microns) of the light detector and cannot resolve subcellular structures. In addition, this device cannot perform imaging at high throughput rates.

### BRIEF SUMMARY OF THE INVENTION

Embodiments of the present invention relate to methods of using an OFM device(s) to analyze fluid samples having suspended objects such as cells and/or microorganisms. The fluid sample is introduced into the OFM device(s) and flows through a fluid channel over a light detector. The light detector takes time varying data of light passing through the objects. The time varying data is used to generate high resolution images of the objects. The images are used to analyze the objects for various applications.

In a quantitative phenotype characterization application, the images are used to classify microorganisms in a fluid sample into different strains (e.g., phenotypes) and the number of microorganisms of each strain is determined. In a water quality monitoring application, the images are used to determine the number and/or type of microbial cells in a water sample. In a blood analysis and diagnostic application, the images are used to determine whether certain cells are present in a blood sample such a tumor cells, stem cells, leukocytes, blood cells with parasites causing malaria, etc. Then, illnesses may be diagnosed based on the types of cells present in the blood sample. The above methods can be used separately or in combination.

One embodiment is directed to a method comprising providing a fluid sample having objects to an optofluidic microscope device comprising a fluid channel and a light detector and receiving time varying light data from the fluid sample. The method also comprises determining one or more characteristics of the objects based on the time varying light data and determining one or more phenotypes associated with the objects based on the determined characteristics.

Another embodiment is directed to a method of determining sample quality comprising providing a fluid sample to an optofluidic microscope device comprising a fluid channel and a light detector wherein the fluid sample comprises one or more objects of a type. The method also comprises receiving time varying light data from the fluid sample, determining a number of the one or more objects of the type based on the time varying light data, and determining the sample quality based on the number of the one or more objects of the type.

Another embodiment is directed to a method comprising providing a blood sample having objects to an optofluidic microscope device comprising a fluid channel and a light detector and receiving time varying light data from the blood sample. The method also comprises determining a characteristic of a portion of the objects based on the time varying light data and diagnosing an illness based on the characteristic of the portion of the objects.

Another embodiment is directed to a method providing a fluid sample having one or more stem cells to an optofluidic microscope device comprising a fluid channel and a light detector, wherein the one or more stem cells is labeled. The method also comprises receiving time varying light data from the fluid sample associated with the labeled one or more stem cells and identifying the one or more stem cells in the fluid sample based on the time varying light data.

One embodiment is directed to a method comprising providing a fluid sample having one or more viruses to an optofluidic microscope device comprising a fluid channel and a light detector and receiving time varying light data from the fluid sample associated with light of a wavelength. The method also comprises identifying the one or more viruses in the fluid sample based on the time varying light data associated with a resolution size less than the wavelength of the light.

These and other embodiments of the invention are described in further detail below.

### BRIEF DESCRIPTION OF THE DRAWINGS

FIG. 1 is a block diagram of a system, according to embodiments of the invention.

FIG. 2 is a flow chart of a method of performing quantitative phenotype characterization of objects (e.g., C. elegans) in a fluid sample, according to an embodiment of the invention.

FIG. 3(a) includes images of three phenotypes of objects (C. elegans), which were generated using an OFM device, according to an embodiment of the invention.

FIG. 3(b) includes two graphs showing the phenotype characteristics of the three phenotypes of objects (e.g., C. elegans) of FIG. 3(a), according to an embodiment of the invention.

FIG. 4 is a flow chart of a method of detecting objects (e.g., microbial cells) in a fluid sample (e.g., water sample), according to embodiments of the invention.

FIG. 5 is a schematic drawing of a filter filtering a fluid sample, according to an embodiment of the invention.

FIG. 6 is a schematic drawing showing immunolabeling of objects in a fluid sample, according to an embodiment of the invention.

FIG. 7(a) is a schematic drawing of a top view of an OFM device having a first filter and a second filter for identifying two types of microbial cells, according to an embodiment of the invention.

FIG. 7(b) is a graph showing the light intensities determined using the OFM device shown in FIG. 7(a), according to an embodiment of the invention.

FIG. 8 is a flow chart of a method of analyzing a blood sample, according to embodiments of the invention.

FIG. 9(a) is a photograph of red blood cells infected with malaria causing parasites.

FIG. 9(b) is an image of a leukocyte generated using an OFM device, according to an embodiment of the invention.

FIG. 10 includes images of two pollen spores generated using an OFM device driven by electrokineteics, according to an embodiment of the invention.

### DETAILED DESCRIPTION OF THE INVENTION

Embodiments of the present invention will be described below with reference to the accompanying drawings. Embodiments are directed to methods of using an optofluidic microscope device(s) to analyze objects in a fluid sample. The fluid sample is introduced into a fluid channel of an OFM device. The fluid channel is illuminated by an illumination source. As the fluid sample flows through the fluid channel, the objects pass over a light detector having a diagonal array of light detecting elements stretching from one lateral side of the fluid channel to another lateral side of the fluid channel. Any light that is not blocked by the objects passes through to the light detecting elements. The light detecting elements generate time varying data about the light that it receives such as intensity and wavelength. The time varying data can be used to generate high resolution images of the objects in the fluid sample.

The images can be used to determine the morphology (size and shape) of the objects in the fluid sample. For example, the images can be used to determine the size (e.g., length and width) of cells and/or microorganisms or structures within them. In addition, the general shape of the cells and/or microorganisms (e.g., spherical, ellipsoidal or elongated) may also be determined from the images. The images can also be used to distinguish the structures within the objects and their sizes. In some cases, stains may be used to better distinguish certain cells or microorganisms and/or structures within them. For example, a fluorescent stain may be used to stain antibodies that bind to the membranes of targeted cells.

The morphological information can then be used to identify the objects and determine the number of objects in various categories. The results of this assessment can be used in numerous biological applications. In a quantitative phenotype characterization application, microorganisms are classified into different strains (e.g., phenotypes) using morphology (e.g., size and shape), and the number of microorganisms in the sample of each strain is determined. In a water quality monitoring application, the number and/or type of microbial cells in a water sample can be determined to evaluate quality. In a blood analysis and diagnostics application, the cells in a blood sample are classified into various types such as tumor cells, stem cells, leukocytes, blood cells with parasites causing malaria, abnormal cells, etc. Various illnesses can be diagnosed based on the number and type of cells identified in the blood sample.

Embodiments of the invention provide advantages over conventional microscopes. One advantage is that a fluid sample can be delivered into the system and analyzed instead of having to prepare slides. Another advantage is that embodiments of the invention provide an inexpensive system capable of providing images with subcellular resolution and detecting viruses. Another advantage is that tens or even hundreds of individual optofluidic microscope devices can be placed on a single compact device. The ability to use a multitude of microscopes on a single compact device allows for parallel imaging of large populations of cells or microorganisms. Parallel imaging allows for high throughput rates. This makes embodiments of the invention highly suited for various clinical applications. Moreover, optofluidic microscope devices of embodiments of the invention may be inexpensive and disposable. In the clinical setting, the ability to dispose of the optofluidic microscope devices could reduce potential cross-contamination risks between specimens. Further, embodiments of the invention can be designed for particular applications such as diagnosing illnesses like malaria. In a Third World environment, low-cost and compact microscope systems suitable for malaria diagnosis could be a boon for health workers with limited resources who often need to travel to isolated areas.

### I. System

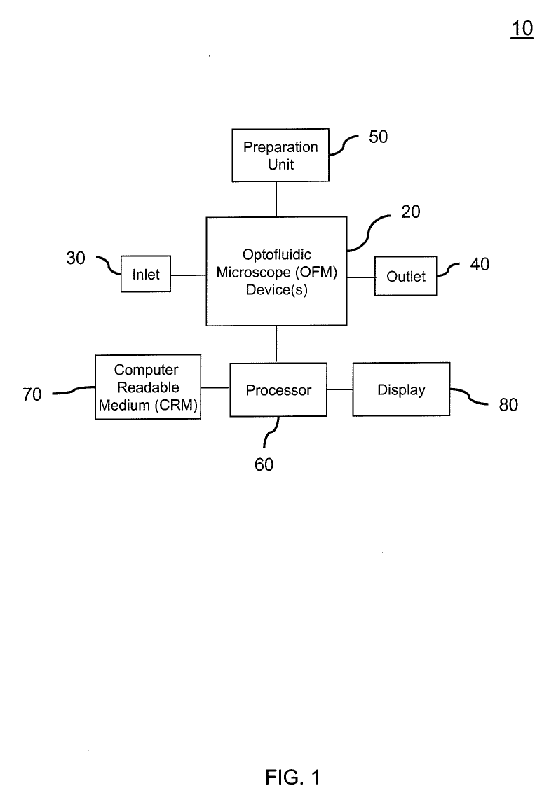

FIG. 1 is a block diagram of a system 10, according to embodiments of the invention. The system 10 includes an OFM device 20 coupled to an inlet 30 and an outlet 40. The inlet 30 is capable of receiving a fluid sample into the OFM device 20 from the user. The outlet 40 provides an exit location for the fluid sample. In another embodiment, OFM device 20 may not have an outlet such as in a disposable single use design.

The system 10 also includes a preparation unit 40 coupled to OFM device 20 to transfer the fluid sample. The preparation unit 40 can perform optional processing functions. The system 10 also includes a processor 60 in electronic communication with the OFM device 20 to receive signals with time varying data. The system 10 also includes a computer readable medium (CRM) (e.g., memory) coupled to the processor 60 for storing code with instructions for performing some functions of the system 10. The code is executable by the processor 60. The system 10 also includes a display 80 coupled to the processor 60 to receive data such as images of objects (e.g., cells and/or microorganisms) from the processor 60. The display 80 provides the data in any suitable format to the user. Although a single OFM device 20 is shown in the illustrated example, the system 10 may include any suitable number of OFM devices 20 arranged in parallel and/or series. The components of system 10 may be separate or combined into one or more devices.

The fluid sample being analyzed by the OFM device 20 can be any suitable sample in a fluid form such as a blood sample, a water sample, etc. In many cases, the fluid sample is in an aqueous solution. Although the object shown in many illustrated examples is a cell or a microorganism, any suitable object can be imaged and analyzed by the system 10. Suitable objects can be biological or inorganic entities. Examples of biological entities include whole cells, cell components such as antibodies, microorganisms such as bacteria or viruses, cell components such as a nucleus, proteins, etc. Inorganic entities may also be imaged by embodiments of the invention.

The OFM device 20 includes a body of one or more layers that defines a fluid channel. The fluid sample being analyzed flows through the fluid channel. The fluid channel may have any suitable dimensions. In some embodiments, the fluid channel may be sized based on the dimensions of the objects being imaged by the OFM device 20 to restrict the movement of the objects. For example, the height of the fluid channel may be 10 microns where the objects being imaged are about 8 microns in order to keep the objects close to the surfaces of the fluid channel and/or to keep objects in a single layer.

The OFM device 20 also includes a light detector (e.g., photosensor). The light detector is any device capable of detecting light and generating signals with time varying data about the intensity, wavelength, and/or other information about the light received. The light detected by the light detector may be radiation having wavelengths from different portions of the spectrum, including, optical radiation, visible radiation, infrared radiation, ultraviolet light, and radiation from other portions. The signals may be in the form of an electrical current that results from the photoelectric effect. Some examples of suitable light detectors include a charge coupled device (CCD) or a linear or two-dimensional array of photodiodes (e.g., avalanche photodiodes (APDs)). The light detector could also be a complementary metal-oxide-semiconductor (CMOS) or photomultiplier tubes (PMTs). Other suitable light detectors are commercially available. In one embodiment, the light detector is located in a surface layer of the body coinciding with a surface of the fluid channel.

The light detector is comprised of one or more light detecting elements that can be of any suitable size (e.g., 1-4 microns) and any suitable shape (e.g., circular or rectangular). The light detecting elements can be arranged in any suitable form such as a one-dimensional array, a two-dimensional array, or a multiplicity of one-dimensional and/or two-dimensional arrays. The arrays can have any suitable orientation or combination of orientations.

The OFM device 20 also includes an illumination source that provides light to the fluid channel. The illumination source may be provided by any suitable device or other source of light such as ambient light. Any suitable wavelength and intensity of light may be used. For example, the illumination source may provide light with a wavelength that will cause activation of fluorophores in the objects. The illumination source may be in any suitable location to provide light which can pass through the object to the light detector. The light provided by the illumination source may be modulated over time. In one embodiment, the light is provided through the opposite surface of the fluid channel in relation to where the light detector is located. The light may be radiation of any suitable wavelength(s) from different portions of the spectrum such as of wavelengths from different portions of the spectrum such as optical radiation, visible radiation, infrared radiation, ultraviolet light, and radiation from other portions.

The system 10 also includes a preparation unit 40 capable of performing suitable processing functions of the OFM device 20 such as a) separating a whole blood sample into fractions, b) immobilizing and/or fixing objects in a fluid sample, c) flushing a fluid sample to remove unbound conjuguate antibodies, d) labeling (e.g., immunolabeling) objects in the fluid sample, e) tagging (e.g., staining) structures within objects, and f) filtering of objects. The preparation unit 40 may include one or more chambers and any suitable device adapted to perform the processing functions of the preparation unit 40.

For example, the preparation unit 40 may include an element capable of immobilizing and/or fixing the objects in the fluid sample. This element may be a heat bath for heating the fluid sample to a predefined temperature that will cause immobilization and/or fixation of the objects. In another case, this element may be a device that provides a drug to be mixed with the sample to immobilize and/or fix the objects.

In another example, the preparation unit 40 has a device for immunolabeling. Immunolabeling can refer to the process of tagging (labeling) conjugate antibodies and introducing them to the fluid sample to bind themselves to the membrane of objects having antigens corresponding to the tagged conjugate antibodies. Any suitable method of tagging can be used such as using fluorescence, gold beads, epitope tag, etc. By tagging the conjugate antibodies, the objects having antigens corresponding to the conjugate antibodies are also tagged. For example, a flourescent stain may be added to conjugate antibodies and the stained conjugate antibodies added to the fluid sample. The stained conjugate antibodies bind to the membrane of the objects having the antigen corresponding to the conjugate antibodies. In this example, preparation unit 40 may also include an flushing element capable of flushing the fluid sample with a buffer water or other solution to remove the unbound conjugate antibodies. Typically, immunolabeling is used where objects are transparent or substantially transparent, to distinguish particular objects, and/or to distinguish particular structures within objects.

In another example, the preparation unit 40 includes a blood separation device that separates whole blood into fractions such as a white blood cells, red blood cells, plasma, etc.

The OFM device 20 also includes a processor 60 in electronic communication with the light detector from which it receives signals with the time varying data from the light detector. The time varying data is associated with the light received by the light detecting elements. The time varying data may include the intensity of the light, the wavelength(s) of the light, and/or other information about the light received by the light detecting elements. The wavelength(s) of light may be from radiation having wavelengths from different portions of the spectrum such as optical radiation, visible radiation, infrared radiation, ultraviolet light, and radiation from other portions. The processor 60 executes code stored on the CRM 70 to perform some of the functions of the OFM device 20 such as interpreting the time varying data from the light detector, generating line scans from the time varying data, and constructing an image of an object moving through the fluid channel from the line scans. The processor 60 can also execute code stored on the CRM to analyze the fluid sample for various applications such as quantitative phenotype characterization, blood analysis and diagnosis of illnesses, and detection of microbial cells for water quality monitoring.

The OFM device 20 also includes a computer readable medium (e.g., memory) and a display 80, in communication with the processor 60. The CRM 70 (e.g., memory) stores the code for performing some functions of the OFM device 20. The code is executable by the processor 60. In one embodiment, the CRM 70 comprises the following: a) code for distinguishing between different biological entities, b) code for determining the rotation and velocity of the object using the data, c) code for determining changes in the shape of the object using the data received from the light detecting elements, d) code for interpreting the time varying data received from the light detecting elements, e) code for performing suitable applications such as cross-correlation and fluorescence applications, f) code for generating line scans from the time varying data received from the light detecting elements, g) code for constructing one or more images from the line scans and/or other data such as rotation or changes in shape of the object, h) code for displaying the image, j) code for performing quantitative phenotype characterization, j) code for performing blood analysis and diagnosis of illnesses, k) code for detection of microbial cells for water quality monitoring, and l) any other suitable code for performing biological applications using the images of the objects. The CRM 70 may also include code for performing any of the signal processing or other software-related functions that may be created by those of ordinary skill in the art. The code may be in any suitable programming language including C, C++, Pascal, etc.

OFM device 20 also includes a display coupled to the processor 60 to receive data from the processor 60. Any suitable display may be used. In one embodiment, the display may be a part of the OFM device 20. The display may provide information such as the image of the object to a user of the OFM device 20 and/or the results of an analysis being performed by the OFM device 20.

As the objects pass through the fluid channel, they can alter (e.g., block, reduce intensity, and/or modify the wavelength) the light from the illumination source. The altered light is received by a light detector. Each discrete light detecting element in the light detector 40 generates time varying data associated with the light it receives. The time varying data is communicated to the processor electronically in the form of a signal. The time varying data from the light detecting elements is dependent on the object profile as well as its optical properties. The processor 90 uses the time varying data to generate a line scan associated with locations of the corresponding light detecting element along an axis orthogonal to a longitudinal axis of the fluid channel and in the plane of the light detecting element. The processor assembles the line scans to generate an image of the objects.

In another embodiment, the system 10 does not have an illumination source and light is provided by the objects. For example, the objects may have activated fluorophores that re-emit light of a wavelength. In this case, the light re-emitted by the objects is received by the light detector as the objects pass through the fluid channel. Each discrete light detecting element in the light detector 40 generates time varying data associated with the light it receives. The time varying data is communicated to the processor electronically in the form of a signal. The time varying data from the light detecting elements is dependent on the object profile as well as its optical properties. The processor 90 uses the time varying data to generate a line scan associated with locations of the corresponding light detecting elements along an axis orthogonal to a longitudinal axis of the fluid channel and in the plane of the light detecting elements. The processor assembles the line scans to generate an image of the objects.

In another embodiment, the OFM device 20 also includes an aperture layer on a surface layer of the fluid channel. The aperture layer is placed between the fluid channel and the light detector. The aperture layer provides sparse sampling of the light from the fluid channel to the light detector.

The fluid channel may also include a water filter (e.g., microfluidic water filter) suitable for filtering out objects larger than a certain size. For example, the water filter may filter out objects larger than a size of 20 μm. The water filter may be located at any suitable location such as orthogonal to the longitudinal axis of the fluid channel and proximal to the inlet 30. Additionally or alternatively, a filter may be located in the preparation unit 50. Any suitable type of filter may be used.

Multiple OFM devices 10 can be located on a single system device in some embodiments. The multiple OFM devices 10 may be arranged in parallel, in series, or in any suitable combination thereof. Multiple OFM devices 10 may provide the capability of automated and parallel imaging of one or more objects. Each of the OFM devices 10 is coupled to the inlet 30 and the outlet 40. In a parallel arrangement, the inlet 30 couples to the multiple fluid channels 20 that feed into the multiple OFM devices. The multiple fluid channels converge to the outlet 40. In operation, the fluid sample is introduced at the inlet 30. The fluid sample then flows into the multiple fluid channels and out through the outlet 40. In a serial arrangement, the inlet 30 couples to the first OFM device 10 and the last OFM device 10 couples to the outlet 40. The series can include any number of OFM devices 10 coupled to each other between the first and last device such that the fluid sample will pass through each OFM device 20 as it travels from the inlet 30 to the outlet 40.

In some embodiments, the OFM device 20 includes filters and uses fluorescence to image all or portions of objects. A filter can refer to any device suitable for allowing light of certain wavelengths to pass and absorbing or reflecting light of other wavelengths. Some suitable devices include optical filters (e.g., dichroic filter), dielectric filters, etc. In one exemplary embodiment, the filter is an optical color filter (e.g., a green filter) that allows light of a narrow range of wavelengths associated with a color (e.g., green) and filters out other wavelengths associated with other colors. For example, the illumination source may emit blue light to excite certain fluorophores in portions of the object. The fluorophores may emit green light in response to being excited by the blue light. The filter may be a green filter that blocks out the blue light from the illumination source and allows only the green light be emitted from fluorophores in the object to pass through to the light detector. The OFM device 20 may include any suitable number of filters at suitable locations.

II. Methods of using OFM (Optofluidic Microscope) Devices
A. Quantitative Phenotype Characterization using OFM Devices

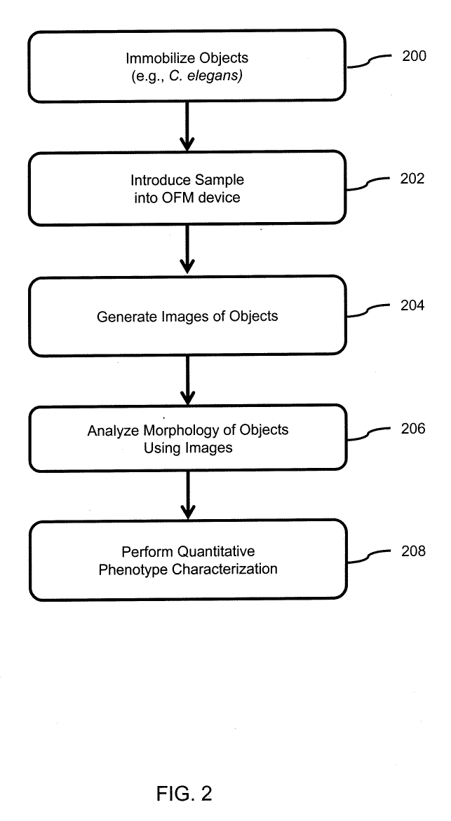

FIG. 2 is a flow chart of a method of performing quantitative phenotype characterization of objects (e.g., C. elegans) in a fluid sample according to an embodiment of the invention. This method can be used to automatically image and analyze the different object phenotypes in a fluid sample using the system 10 having the OFM device 20. For example, object phenotypes at different stages of development or mutated strains of object phenotypes can be analyzed. This method can provide an inexpensive means for conducting automated and quantitative phenotype characterization in biological studies.

Although the objects being characterized in the illustrated example are C. elegans, any suitable entity can be characterized using this method. In addition, any suitable number of objects can be characterized using this method. In one exemplary embodiment, hundreds to thousands of objects can be characterized using a single device having multiple OFM device(s) arranged in parallel and/or in series. By placing multiple OFM devices 20 on the same device, the device can perform parallel processing and achieve higher throughput.

Optionally, the method starts by immobilizing the objects (e.g., C. elegans) (step 200). The objects can be immobilized by any suitable method such as placing the objects in a heat bath or introducing an immobilizing drug into the biological fluid sample. Immobilizing may be performed by any suitable component of the system 10. For example, the preparation unit may immobilize the objects. In other examples, an immobilizing element may be entirely separate or integrated into another portion of the system 10 such as the fluid channel. In other embodiments, the objects are not immobilized.

The fluid sample is introduced into the fluid channel of the OFM device(s) 20 (step 202). Any suitable method can be used introduce the fluid sample into the OFM device 20. For example, the biological fluid sample can be injected into an inlet 30 of the OFM device 20 or the biological fluid sample can be poured into a funnel coupled to the inlet 30 of the OFM device 20. In one embodiment, the fluid sample is introduced into a device having multiple OFM devices 20 to parallel or serially process multiple objects.

After the fluid is introduced into the fluid channel, the OFM device(s) 20 generates images of the objects (step 204). As objects in the fluid sample flow through the fluid channel (or series of fluid channels) in the OFM device(s) 20, light from an illumination source passes through the fluid channel and is altered by the objects. As the objects move through the channel 20, the light detecting elements receive the altered light. Each discrete light detecting element of the light detector generates time varying data regarding the light received such as the intensity and wavelength. The light detecting elements send the time varying data in an electronic signal to the processor 60. The processor 60 generates line scans from the time varying data and assembles images of the objects based on the line scans.

The processor 60 can use the OFM images generated by the OFM device(s) 10 to analyze the morphology of the objects (step 206). The processor 60 analyzes the images to determine value of certain morphological characteristics of the objects or structures within the objects. Suitable morphological characteristics include length, width, or general shape of the objects or structures within the objects. For example, the processor 60 may determine that the lengths of six objects (S₁, S₂, S₃, S₄, S₅, S₆) in a fluid sample are respectively: L₁=250 μm, L₂=256 μm, L₃=216 μm, L₄=220 μm, L₅=196 μm, and L₆=202 μm and the widths of the six objects respectively are: W₁=11.6 μm, W₂=11.8 μm, W₃=11.3 μm, W₄=11.5 μm, W₅=12.0 μm, and W₆=12.3 μm.

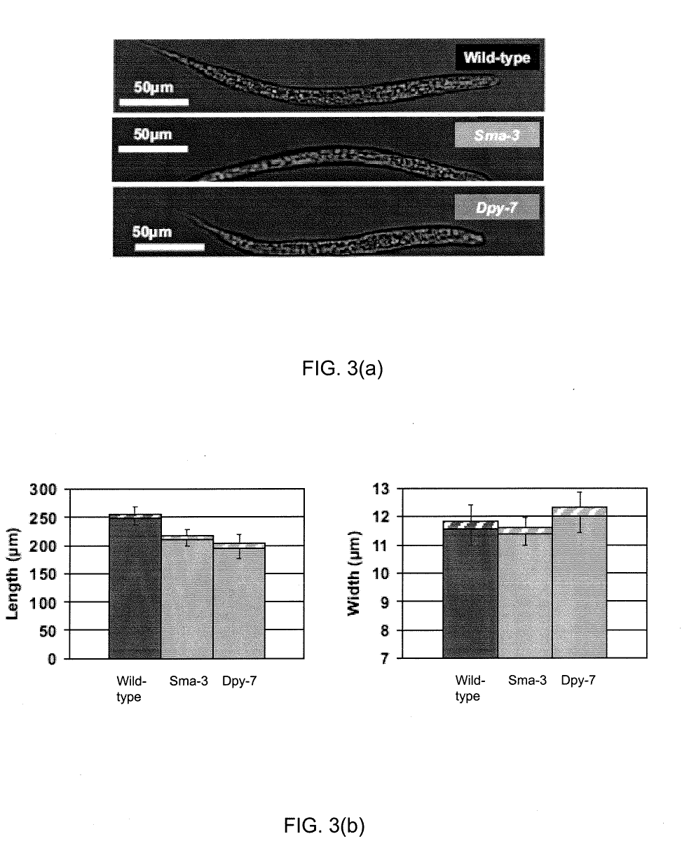

FIG. 3(a) includes images of three phenotypes of objects, which were generated using an OFM device 20, according to an embodiment of the invention. The objects are in the form of C. elegans. In the top image, the C. elegan is of the Wild-Type phenotype. In the middle image, the C. elegan is of the Sma-3 phenotype. In the bottom image, the C. elegan is of the Dpy-7 phenotype.

Using the values of the morphological characteristics, the processor 60 can perform a quantitative phenotype characterization to determine the number of objects in the sample belonging to the different phenotypes (step 208). The processor 60 first determines the phenotypes in the fluid sample. The processor 60 groups together similar values of the morphological characteristics. For example, the processor 60 may group together the lengths of the objects in the previous example as: L₁=250 μm and L₂=256 μm; L₃=216 μm and L₄=220 μm; and L₅=196 μm and L₆=202 μm. The processor 60 may also group together: W₁=11.6 μm and W₂=11.8 μm; W₃=11.3 μm and W₄=11.5 μm; and W₅=12.0 μm and W₆=12.3 μm. In both cases, the processor 60 has determined that S₁ and S₂ have similar morphological characteristic values, that S₃ and S₄ have similar morphological characteristic values, and S₅ and S₆ have similar morphological characteristic values. Based on this grouping, the processor 60 determines that there are three phenotypes (Wild-Type, Sma-3, and Dpy-7) in the fluid sample and that the two objects S₁ and S₂ belong to phenotype Wild-Type, the two objects S₃ and S₄ belong to Sma-3, and the two objects S₅ and S₆ belong to Dpy-7.

In another embodiment, the processor 60 may retrieve a library of stored morphological characteristic values for particular phenotypes or images of phenotypes from the CRM 70 or other memory. The processor 60 may compare the determined value of the morphological characteristics for each object in the sample to the stored morphological characteristic values for particular phenotypes or the image to determine the phenotype associated with each object.

After the phenotypes are determined, the processor 60 can also determine statistical averages and variations of each phenotype characteristic using the value of the characteristics for the objects in the sample. For example, the processor 60 may determine that the Wild-Type phenotype has an average length of L=253 μm=(L₁=250 μm+L₂=256 μm)/2 and an average width of W=11.7 μm (W₁=11.6 μm+W₂=11.8 μm)/2.

FIG. 3(b) includes two graphs showing the phenotype characteristics of the three phenotypes of objects (e.g., C. elegans) of FIG. 3(a), according to an embodiment of the invention. The graphs show the average values and the statistical variations in the fluid sample for the phenotype characteristics of Length and Width for the three phenotypes Wild-type, Sma-3, and Dpy-7. Details about an OFM device 20 that is used to perform a quantitative phenotype characterization of C. elegans can be found in Xiquan Cui, Lap Man Lee, Xin Heng, Weiwei Zhong, Paul W. Sternberg, Demetri Psaltis & Changhuei Yang, Lensless high-resolution on-chip optofluidic microscopesfor Caenorhabditis elegans and cell imaging, Proceedings of the National Academy of Science Vol. 105, 10670 (2008), which is incorporated herein by reference in its entirety for all purposes.

B. Method for Detection of Objects (e.g., Microbial Cells) in Fluid Sample

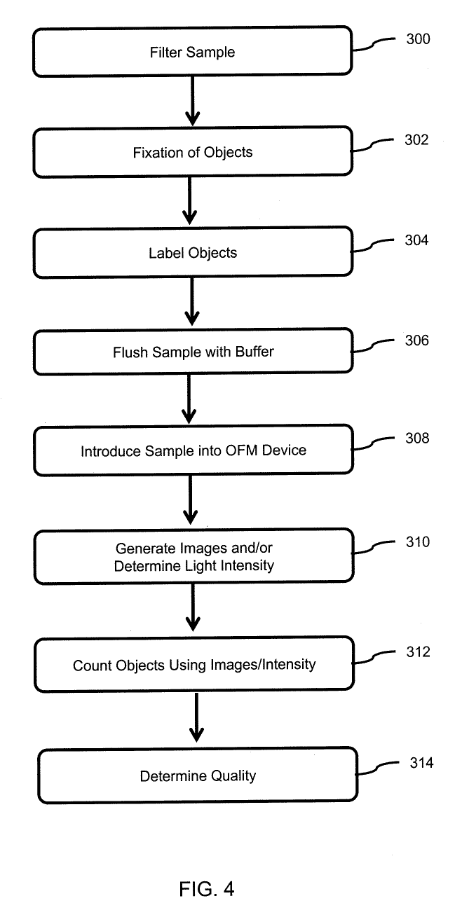

FIG. 4 is a flow chart of a method of detecting objects (e.g., microbial cells) in a fluid sample (e.g., water sample), according to embodiments of the invention. In an exemplary embodiment, the method is used to detect microbial cells of a size <10 μm (e.g., oocysts and Giardia lamblia cysts) in a water sample and determine whether the level (number) of these microbial cells in the water sample is safe for human consumption. In other embodiments, other microorganisms of other suitable sizes or other objects can be detected for other suitable purposes.

The method begins by filtering larger objects from the fluid sample using the OFM device 20 (step 300). In the illustrated example, the objects being filtered from the fluid sample are objects having a predefined size greater than 10 μm such that the fluid sample is left with objects less than 10 μm. Filtering may be performed in any suitable component of the OFM device 20 such as in the preparation unit 50 or in the fluid channel. The filter may be suitably located with the component filtering the fluid sample. Some examples of filtering OFM devices 10 can be found in Lab Chip, 2004, 4, 337-341, DOI: 10.1039/b401834f; Lab Chip, 2008, 8, 830-833, DOI: 10.1039/b600015h; and Christophe Lay, Cheng Yong Teo, Liang Zhu, Xue Li Peh, Hong Miao Ji, Bi-Rong Chew, Ramana Murthy, Han Hua Feng, Enhanced microfiltration devices configured with hydrodynamic trapping and a rain drop bypass filtering architecture for microbial cells detection, which is incorporated herein by reference in its entirety for all purposes.

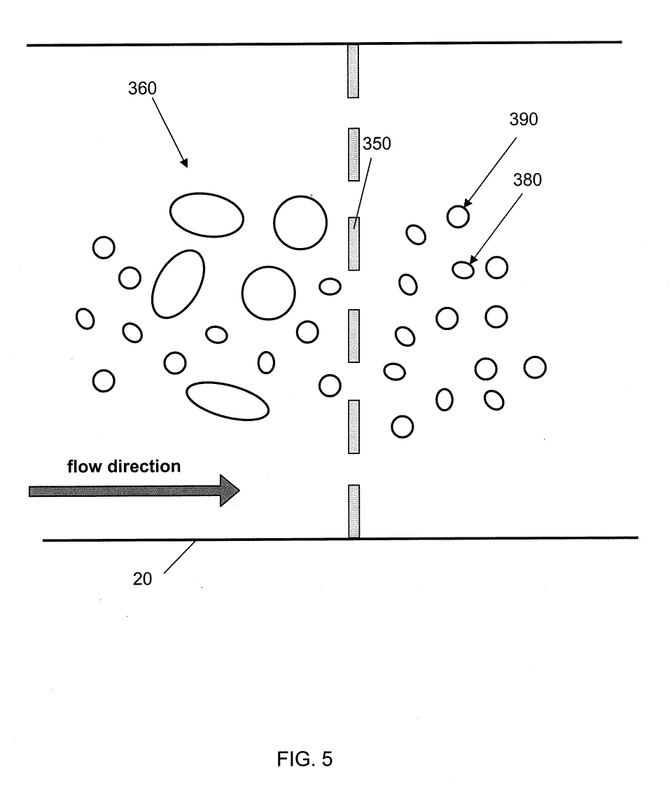

FIG. 5 is a schematic drawing of a filter 350 filtering a fluid sample, according to an embodiment of the invention. In this example, the filter 350 prevents the larger objects 360 from passing and allows the microbial cells Type I 380 and microbial cells Type II 390 to pass through the filter. As the fluid sample flows through the fluid channel, the filter 350 removes the larger objects 360 from the fluid sample.

After or before filtering out the larger objects, the objects in the fluid sample are fixed (step 302). The objects can be fixed by any suitable method such as placing the objects in a heat bath or introducing a fixing drug into the fluid sample. Any suitable component of the OFM device 20 such as the preparation unit 50 can fix objects. In other embodiments, the objects are not fixed.

Next, the objects in the fluid sample are labeled (step 304). Labeling can be performed by any suitable process. An exemplary embodiment uses immunolabeling, which refers to the process of tagging conjugate antibodies and introducing them to the fluid sample to bind themselves to the membrane of objects having antigens corresponding to the tagged conjugate antibodies. Any suitable method of tagging can be used such as using fluorescent staining, gold beads, epitope tag, etc. By tagging the conjugate antibodies, the objects having the antigens corresponding to the conjugate antibodies are also tagged. For example, a flourescent stain may be applied to conjugate antibodies and the stained conjugate antibodies added to the fluid sample. The stained conjugate antibodies bind to the membrane of the objects having the antigen corresponding to the conjugate antibodies. Labeling may be performed by a device entirely separate from the system 10, or incorporated into any suitable component of the system 10 such as the preparation unit 50.

After the tagged conjugate antibodies bind to the objects, the fluid sample is flushed with buffer solution (step 306). Flushing the fluid sample removes a substantial portion of the unbound conjugate antibodies in the fluid sample. Flushing may be performed entirely separate from the system 10 or by any suitable component of the system 10 such as the preparation unit 50.

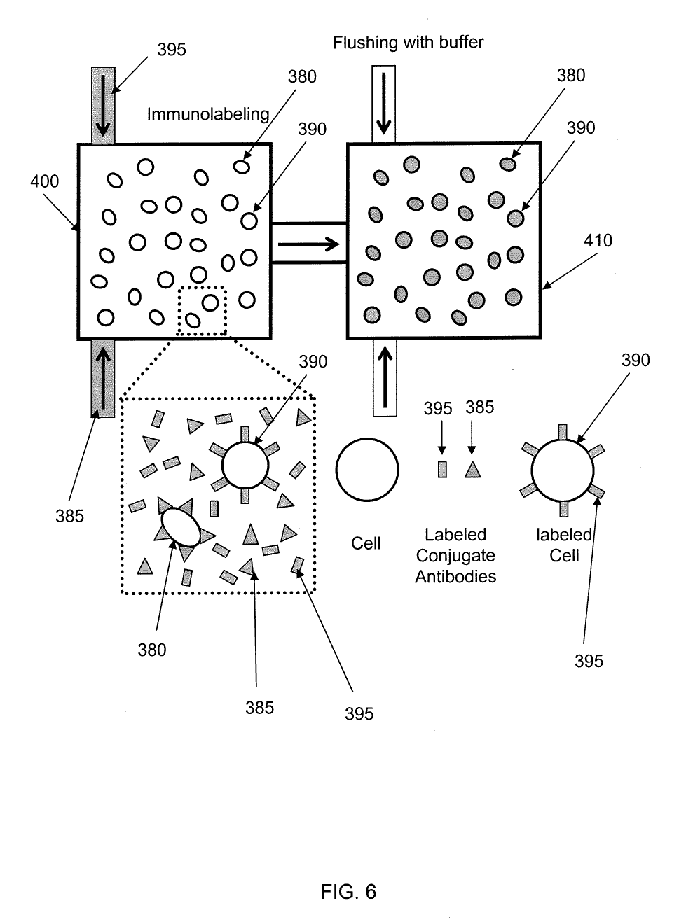

FIG. 6 is a schematic drawing showing immunolabeling of objects in a fluid sample, according to an embodiment of the invention. In this example, a first tagged conjugate antibodies 385 and a second tagged conjugate antibodies 395 are introduced into a chamber 400 with the fluid sample having microbial cells Type I 380 and microbial cells Type II 390. The tagged conjugate antibodies 385 are represented by triangles and the second tagged conjugate antibodies 395 are represented by rectangles. Once the tagged conjugate antibodies are introduced into the fluid sample, the tagged conjugate antibodies bind specifically to the membranes of the microbial cells. In this case, the tagged conjugate antibodies 385 bind to the microbial cells Type I 380 and the tagged conjugate antibodies 395 bind to the microbial cells Type II 390. The fluid sample is then sent to a second chamber 410 and flushed with a buffer to remove the unbound tagged conjugate antibodies. An example of an OFM device used to perform immunolabeling can be found in Liang Zhu, Qing Zhang, Hanhua Feng, Simon Ang, Fook Siong Chau and Wen-Tso Liu, Filter-based microfluidic device as a platform for immunofluorescent assay of microbial cells, which is incorporated herein by reference in its entirety for all purposes.

After labeling, the fluid sample is introduced into the OFM device(s) 10 (step 308). The OFM device(s) 10 generates images of the objects and/or determines the overall light intensity of the fluid sample (step 310).

In one embodiment, an activation light of a certain wavelength (e.g., blue light) illuminates the objects in the fluid channel or outside the fluid channel when the fluid sample is flowing inside the OFM device(s) 10. The activation light excites the fluorophores in tagged conjugate antibodies which re-emit light of another wavelength (e.g., green light). An optical filter (e.g., green filter) over one or more light detecting elements allows light of wavelengths associated with a color (e.g., green) and filters out other wavelengths (e.g., blue light) associated with other colors. The light detecting elements receive the re-emitted light (e.g., green light) as the objects with the tagged conjugate antibodies move through the channel 20. Each discrete light detecting element of the light detector generates time varying data about the received light. The light detecting elements send the time varying data in an electronic signal to the processor 60. The processor 60 generates line scans from the time varying data and assembles images of the objects based on the line scans. Additionally or alternatively, the processor 60 can determine the light intensity from tagged conjugate antibodies in the fluid sample using the time varying data. In another embodiment, the fluid sample is illuminated with an activation light separately from system 10 or by another component of system 10.

In an illustrated embodiment, the processor 60 counts the number of objects in the fluid sample using the generated images and/or using the determined intensity (step 310). The processor 60 can use any suitable counting algorithm to count the number of objects based on the generated images. The processor 60 can also use the overall light intensity to determine the number of objects in the fluid sample. For example, an intensity Y may correspond to Z objects per unit volume of fluid. The values of the intensity Y to the Z objects per unit volume may be stored in the CRM. The processor 60 may compare the determined light intensity to the stored values to determine the concentration of objects in the fluid sample. For example, experimental data may show that a light intensity of 10 cd indicates that 70 microbial cells/cc are present.

The processor 60 can use the number of objects to determine the sample quality (step 314). Concentration standards can be stored on the CRM 70. The processor 60 can determine the sample quality by comparing the concentration of objects in the fluid sample to values standard. For example, the standards may indicate that the sample quality is poor if the fluid sample has X objects per cc. The processor 60 has determined that there are 2× objects per cc. Comparing 2× objects to the X objects per cc, the processor 60 determines that the quality is poor. In an exemplary embodiment, the processor 60 determines the water quality of a water sample based on the number of microbial cells <10 μm to determine whether the water sample is safe for human consumption. In this case, the values for the maximum concentration of microbial cells <10 μm that are considered safe for human consumption may be stored on the CRM. The processor 60 retrieves this maximum concentration and compares it to the determined number of microbial cells. If the processor 60 determines that the concentration of microbial cells is more than the maximum, the processor 60 will determine that the water is not safe for consumption. If less, the processor 60 determines the water is safe for human consumption.

After the processor 60 determines the sample quality, the processor 60 may generate a message that is displayed on the display 110 to indicate the sample quality. In the embodiment that determines water quality, the processor may send a message to the display 110 indicating the quality of water. The quality may be expressed along a continuum from poor to excellent.

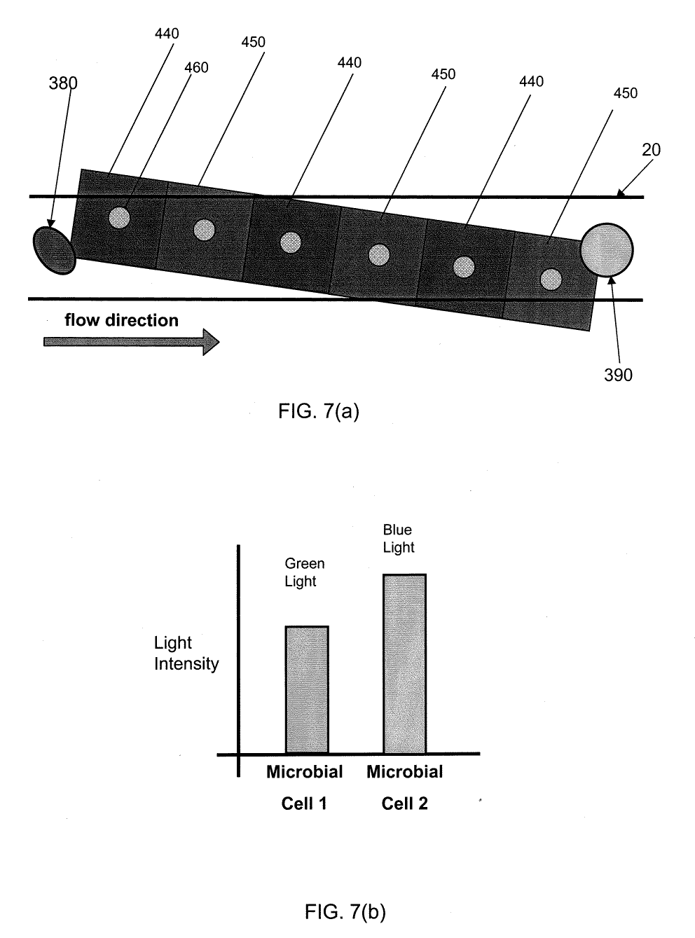

In another embodiment, multiple light filters may be used to identify different types of objects where each object is labeled differently. The embodiment shown in FIG. 7(a) describes an OFM device 20 having two types of light filters and allows the identification of two types of microbial cells.

FIG. 7(a) is a schematic drawing of a top view of an OFM device 20 having a first filter 440 and a second filter 450 for identifying two types of microbial cells (microbial cells Type I 380 and microbial cells Type II 390), according to an embodiment of the invention. In the illustrated example, the OFM device 20 includes a fluid channel. A microbial cell Type I 380 and a microbial cell Type II 390 move through the fluid channel in the flow direction along the longitudinal axis of the fluid channel. Microbial cell Type I 380 is labeled with tagged conjugate antibodies 385 which have fluorophores that re-emit light of a wavelength I (green light). The first filter 440 (green filter) allows only light of a wavelength I to pass through to the light detecting elements 460 covered by the first filter 440. Microbial cell Type II 360 is labeled with tagged conjugate antibodies 395 which have fluorophores that re-emit light of wavelength II (blue light). The second filter 450 (blue filter) allows light of wavelength II to pass through to the light detecting elements 460 covered by the second filter 450. The light detecting elements 460 covered by the first filter 440 (green filter) detect the light of the wavelength I (green light) re-emitted from the microbial cell Type I 1380. The light detecting elements 460 covered by the second filter 450 (blue filter) detect the light of wavelength II (blue light) re-emitted from the microbial cell Type II 390. As the sample fluid flows through the fluid channel, the light detecting elements 460 receive the light of the wavelength I and wavelength II and generate time varying data based on the received light. The light detecting elements 460 send the time varying data in a signal to the processor 60. The processor 60 uses the data to generate images of the microbial cells and determines the number of microbial cells of each type in the fluid sample based on the generated images.

The processor 60 may also use the data to determine an overall light intensity re-emitted by the labeled objects in the fluid sample, which can be used to determine the number of microbial cells in the fluid sample. FIG. 7(b) is a graph showing the light intensities determined using the OFM device 20 shown in FIG. 7(a), according to an embodiment of the invention. In the illustration, the intensities of light from the microbial cells Type I 380 (green light) and microbial cells Type II 390 (blue light), according to an embodiment of the invention.

C. Method of Blood Analysis and Illness Diagnosis

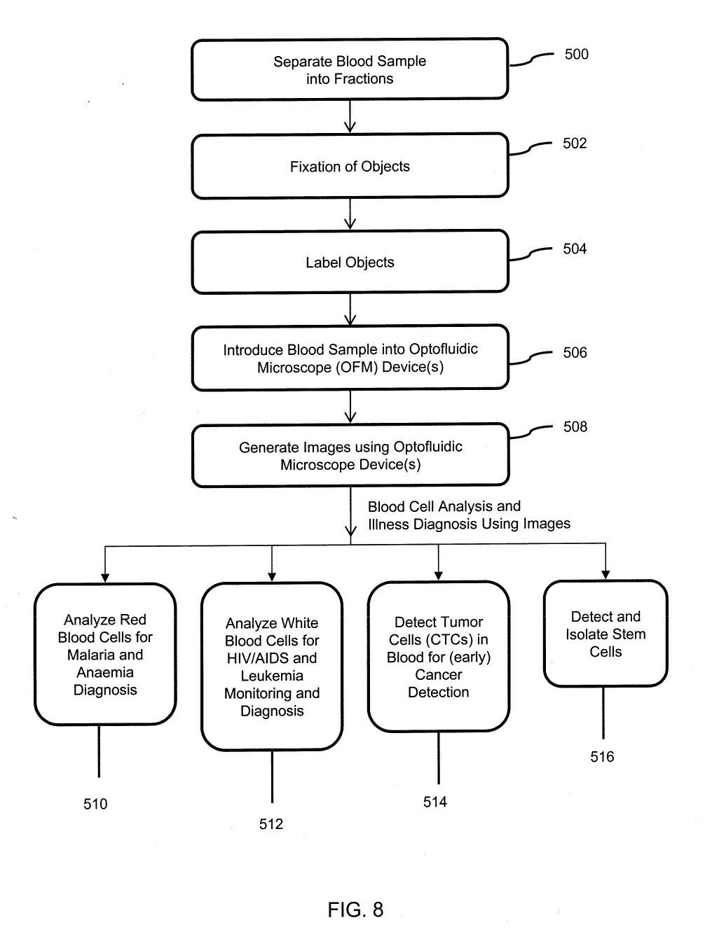

FIG. 8 is a flow chart of a method of analyzing a blood sample, according to embodiments of the invention. The blood sample is in a fluid form. This method can be used to analyze a blood sample and diagnose an illness and/or determine that certain cells or cell structures are present in the blood sample. In some cases, this method may provide an inexpensive means to automate blood analysis and/or illness diagnosis without the need of slide preparation or skilled technicians.

The method begins by separating a blood sample into fractions (step 500). Fractions can refer to portions of the blood sample associated with specific types of blood cells such as red blood cells, white blood cells, plasma, platelets, etc. Any suitable method for separating the blood sample into fractions can be used. Separation into fractions can be performed separately from system 10 or by any suitable component of the system 10 (e.g., the preparation unit). In some embodiments, the blood sample is not separated into fractions. For example, some embodiments of the method analyze a whole-blood sample.

One or more fractions may be selected for further analysis. Next, the objects (e.g., cells) in the blood sample with the selected fractions are fixed (step 502). The objects can be fixed by any suitable method such as placing the blood sample in a heat bath or introducing a fixing drug into the blood sample. A fixing element may be entirely separate or can be integrated into any suitable component of the system 10 such as the preparation unit 50. In other embodiments, the objects are not fixed.

Next, the objects (e.g., cells) in the blood sample are labeled (step 504) such as by immunolabeling. Labeling may be performed by any suitable component of the system 10 such as the preparation unit. If immunolabeling is used, the tagged conjugate antibodies bind to the objects, the fluid sample is flushed with buffer to substantially remove the unbound conjugate antibodies in the blood sample. Flushing may be performed separate from system 10 or by any suitable component of the system 10 such as the preparation unit. In some embodiments, objects are not labeled. In one embodiment, labeling may not be necessary where the objects (e.g., cells) are not transparent and/or have color. For example, red blood cells have hemoglobin which has a color associated with the oxygen content of the cells and may not require immunolabeling to image the objects.

After labeling, the blood sample is introduced into the OFM device(s) 10 (step 506). Any appropriate method of labeling may be employed if necessary. The OFM device(s) 10 then generates images of the objects (step 508). After the objects in the blood sample are imaged, one or more blood analyses and/or illnesses diagnosis can be performed by the processor 60.

In a first case, the processor 60 can analyze a blood sample having a red blood cell fraction to diagnosis certain illnesses such as Anaemia and Malaria (step 510). Malaria is a disease caused by protozoan parasites that infect red blood cells. The infected red blood cells have a different morphology (shape) than normal healthy red blood cells. In addition, the infected blood cells have malaria causing parasites (Plasmodium falciparum) and/or gametocytes within which are opaque and can be imaged.

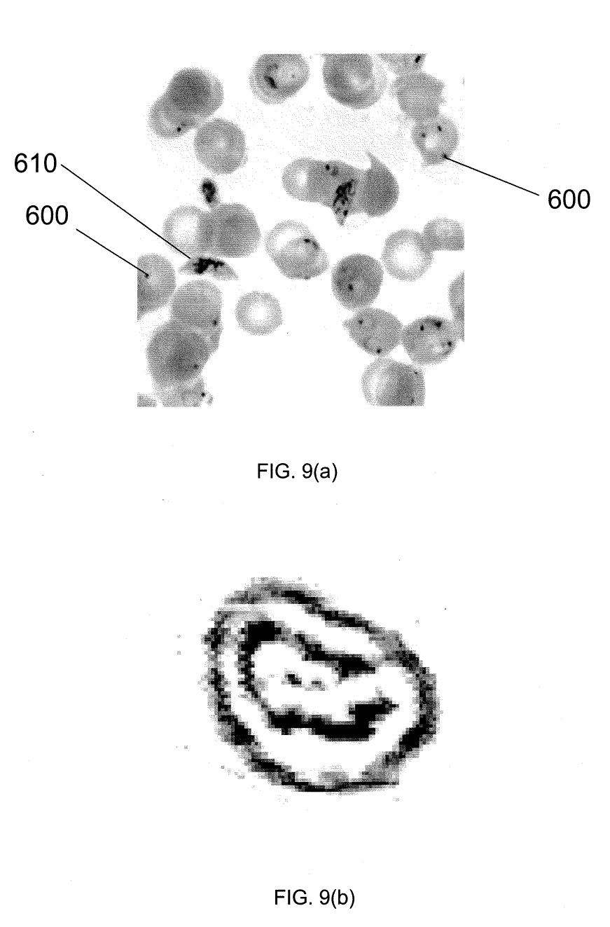

FIG. 9(a) is a photograph of red blood cells infected with malaria causing parasites 600. The malaria causing parasites 600 are visible in the red blood cells. The red blood cells at later stages 610 have a different shape than the biconcave shape of the healthy red blood cells.

The processor 60 uses the generated images of the red blood cells in the blood sample to determine whether the red blood cells are infected with Malaria causing parasite. The processor 60 may determine whether the red blood cells have a different shape than healthy red blood cells and/or may determine whether the red blood cells have parasites and/or gametocytes. The processor 60 diagnoses malaria based on this determination.

The processor 60 can also use generated images of the red blood cells in the blood sample to determine whether the red blood cells in the blood sample are smaller than healthy red blood cells and determine the number of red blood cells in the blood sample. The processor 60 can make a diagnosis of Anemia based on these determinations.

In second case, the processor 60 can analyze a blood sample having a white blood cell fraction to diagnose certain illnesses such as HIV/AIDS, Leukemia, etc. (step 512). Typically, immunolabeling or other labeling is used to differentiate the different types of white blood cells (leukocytes) and to differentiate certain proteins (e.g., glycoproteins) within the cells such as the CD4 and CD8. The processor 60 uses the images of the white blood cells to determine the number of certain types of white blood cells (leukocytes) in the blood sample such as the number of neutrophils, lymphocytes such as T-cells (T lymphocytes) and B-cells, or monocytes, etc. FIG. 9(b) is an image of a leukocyte generated using an OFM device 20, according to an embodiment of the invention.

The processor 60 also determines the number of certain glycoproteins such as CD4 and CD8 in the blood sample. The processor 60 may also analyze the morphology of the white blood cells to determine the immature and abnormal white blood cells and determine the number of these cells.

The processor 60 may also determine certain illnesses based on the numbers of these cells and glycoproteins. The processor 60 may monitor or diagnosis HIV/AIDS based on the number of (CD4 and T cell) and (CD8 and Tcell) in the blood sample. The processor 60 may monitor or diagnosis Leukemia based on an increase of immature or abnormal white blood cells in the blood sample since the last sample was taken.

In a third case, the processor 60 can analyze a blood sample for early cancer detection (step 514). Tumor cells generally have a larger nucleus and a higher light absorption coefficient than healthy cells. Circulating tumor cells in blood can indicate an early stage of malignant cancer. The processor 60 can detect the tumor cells in a blood sample by identifying any cells with large and/or dark nucleuses using the generated images. The processor 60 can provide these results to the user. Based on this detection, physicians may determine that more aggressive therapy or treatment is needed, which may improve patient care and survivorship.

In a fourth case, the processor 60 can analyze a blood sample to detect and isolate stem cells (step 516). Stem cells can be differentiated by immunolabeling. The processor 60 may detect the stem cells based on images made possible by the presence of tagged conjugate antibodies on the stem cells. The stem cells can then be isolated.

Fluorescent dyes can be used to tag different compartments or organelles in cells such as the nucleus, cytoskeleton, and membrane proteins. In one embodiment, fluorescent dyes can be used to tag certain cytoskeleton structures in cells such as actin filaments and microtubules of cells. The processor 60 can generate high resolution images of the cytoskeleton structures in the cells. The processor 60 can use the images of the tagged cytoskeleton structures to differentiate between different species of cells. The processor 60 may also be able to analyze tagged cytoskeleton structures to provide information for cytoskeleton-related studies and diagnose cytoskeleton-related diseases. In another embodiment, fluorescent dyes can be used to tag certain membrane proteins. Several membrane proteins are important in the regulation of physiology of the cells such as sodium/potassium ion pumps and the G-proteins. Using the generated images of the tagged membrane proteins, the processor 60 can detect membrane proteins and diagnosis diseases caused by certain membrane proteins such as cystic fibrosis. In addition, membrane receptors like nicotine receptors can be tagged. The processor 60 can generate images of the nicotine receptors and study the relationship between smoking and cancer based on these images.

D. High Resolution OFM

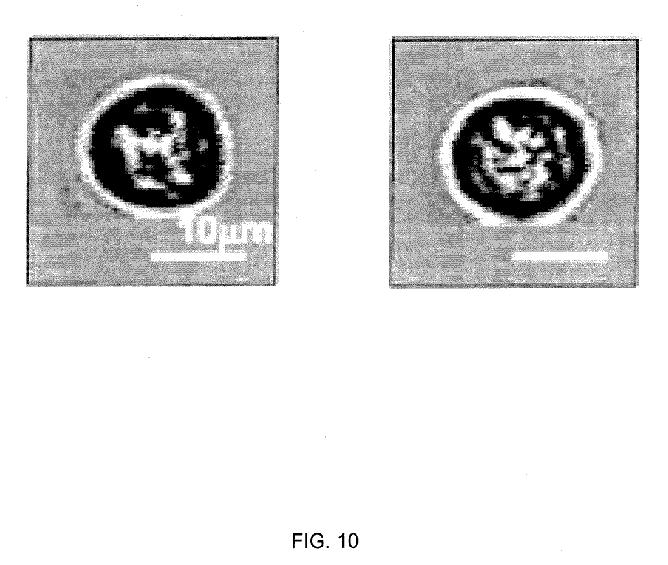

Certain embodiments of the system 10 can be used to generate high resolution images of approximately 110 nm. The resolution generated by these embodiments can reach a size less than the size of the wavelength of light received by the light detecting elements. These embodiments may be used to detect and diagnose viruses. FIG. 10 includes images of two pollen spores generated using an OFM device 20 driven by electrokineteics, according to an embodiment of the invention. The system 10 provides a low cost technique for identifying viruses. The system 10 also provides a more effective way of detecting viruses based on morphology.

In one embodiment, the processor 60 can identify viruses from other objects in a fluid sample based on the morphology (shape, size) of the viruses. The processor 60 generates images of the objects in the fluid sample and identifies the viruses based on the morphology evident in the images. The processor 60 can also analyze the images to determine the types of viruses. Alternatively or additionally, the generated images of the objects in the fluid sample may be provided to the user (e.g., virologist or clinician) on the display 110 to allow the user to identify the viruses from the displayed images.

It should be understood that the present invention as described above can be implemented in the form of control logic using computer software in a modular or integrated manner. Other ways and/or methods to implement the present invention using hardware and a combination of hardware and software may also be used.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

A recitation of “a”, “an” or “the” is intended to mean “one or more” unless specifically indicated to the contrary.

The above description is illustrative and is not restrictive. Many variations of the disclosure will become apparent to those skilled in the art upon review of the disclosure. The scope of the disclosure should, therefore, be determined not with reference to the above description, but instead should be determined with reference to the pending claims along with their full scope or equivalents.

One or more features from any embodiment may be combined with one or more features of any other embodiment without departing from the scope of the disclosure. Further, modifications, additions, or omissions may be made to any embodiment without departing from the scope of the disclosure. The components of any embodiment may be integrated or separated according to particular needs without departing from the scope of the disclosure.

What is claimed is:

1. A method comprising:
providing a fluid sample having objects to an optofluidic microscope device comprising a fluid channel and a light detector;
receiving time varying light data from the fluid sample;
determining one or more characteristics of the objects based on the time varying light data; and
determining one or more phenotypes associated with the objects based on the determined characteristics.

2. The method of claim 1, further comprising determining a number of objects associated with each of the phenotypes.

3. The method of claim 1, further comprising exposing the fluid sample in the optofluidic microscope device to radiation.

4. The method of claim 1, wherein the one or more characteristics includes a size of an object.

5. The method of claim 4, wherein the size is a length of the object.

6. The method of claim 1, wherein the one or more characteristics includes a shape of an object.

7. The method of claim 1, further comprising immobilizing the objects in the fluid sample.

8. The method of claim 1, wherein determining one or more phenotypes associated with the objects based on the determined characteristics comprises grouping objects with similar determined characteristics.

9. The method of claim 1, wherein determining one or more phenotypes associated with the objects based on the determined characteristics comprises comparing the one or more determined characteristics of the objects with a library of images of phenotypes.

10. A method of determining sample quality, the method comprising:
providing a fluid sample to an optofluidic microscope device comprising a fluid channel and a light detector, wherein the fluid sample comprises one or more objects of a type;
receiving time varying light data from the fluid sample;
determining a number of the one or more objects of the type based on the time varying light data; and
determining the sample quality based on the number of the one or more objects of the type.

11. The method of claim 10, further comprising filtering the fluid sample prior to receiving the time varying light data.

12. The method of claim 10, further comprising fixing the objects in the fluid sample.

13. The method of claim 10, further comprising labeling an object in the fluid sample prior to receiving the time varying light data.

14. The method of claim 13, wherein labeling the object in the fluid sample comprises introducing conjugate antibodies adapted to bind with the object.

15. The method of claim 14, further comprising flushing the fluid sample with a buffer to remove unbound conjugate antibodies.

16. The method of claim 10, further comprising determining a magnitude of a wavelength of transmitted radiation through the fluid sample based on the time varying light data, wherein the number of the one or more objects of the type is determined based on the magnitude.

17. The method of claim 10, further comprising generating images of the one or more objects of the type based on the time varying light data, wherein the number of the one or more objects of the type is determined based on the generated images.

18. The method of claim 10, wherein the objects are microbial cells.

19. The method of claim 10, wherein the quality of the fluid sample is associated with safety for human consumption.

20. The method of claim 10, further comprising exposing the fluid sample in the optofluidic microscope device to light.

21. A method comprising:
providing a blood sample having objects to an optofluidic microscope device comprising a fluid channel and a light detector;
receiving time varying light data from the blood sample;
determining a characteristic of a portion of the objects based on the time varying light data; and
diagnosing an illness based on the characteristic of the portion of the objects.

22. The method of claim 21, wherein the characteristic of the portion of the objects is a shape of the object.

23. The method of claim 21, wherein the characteristic of the portion of the objects is a size of a nucleus.

24. The method of claim 21, further comprising immobilizing the objects in the blood sample.

25. The method of claim 21, further comprising labeling an object in the blood sample.

26. The method of claim 25, wherein labeling the object comprises introducing conjugate antibodies adapted to bind with the object.

27. The method of claim 26, further comprising flushing the blood sample with a buffer to remove unbound conjugate antibodies.

28. A method comprising:
providing a fluid sample having one or more stem cells to an optofluidic microscope device comprising a fluid channel and a light detector, wherein the one or more stem cells is labeled;
receiving time varying light data from the fluid sample associated with the labeled one or more stem cells; and
identifying the one or more stem cells in the fluid sample based on the time varying light data.

29. The method of claim 28, further comprising isolating the one or more stem cells.

30. The method of claim 28, further comprising immobilizing the one or more stem cells in the fluid sample.

31. The method of claim 28, further comprising labeling the one or more stem cells.

32. The method of claim 31, wherein labeling the one or more stem cells comprises introducing into the fluid sample conjugate antibodies adapted to bind with stem cells.

33. The method of claim 32, further comprising flushing the fluid sample with a buffer to remove unbound conjugate antibodies.

34. A method comprising:
providing a fluid sample having one or more viruses to an optofluidic microscope device comprising a fluid channel and a light detector;
receiving time varying light data from the fluid sample associated with light of a wavelength; and
identifying the one or more viruses in the fluid sample based on the time varying light data associated with a resolution size less than the wavelength of the light.
